(19) United States
(12) Patent Application Publication
(10) Pub. No.: US 2026/0028125 A1
(43) Pub. Date: Jan. 29, 2026

(54) Climate Control for Turbine Aircraft

(71) Applicant: Textron Aviation Inc., Wichita, KS (US)

(72) Inventors: Robert Glynn Wiegers, Wichita, KS (US); Clinton Lee Thompson, Wichita, KS (US)

(21) Appl. No.: 18/782,408

(22) Filed: Jul. 24, 2024

(51) Int. Cl. B64D 13/06; B64D 43/00

(52) U.S. Cl. CPC B64D 13/06; B64D 43/00; B64D 2013/0618

(57) ABSTRACT

A hybrid climate control system for a turbine aircraft, including a separate climate controller for each area of the turbine aircraft which can be configured to manually, semi-automatically, or automatically control temperature and fan speeds in that area. Streamlined user interfaces allow for state selections between fully manual, automatic temperature and manual fans, and fully automatic control, where fully automatic control virtually eliminates user distractions caused by climate control issues. A novel means of automatic aircraft fan control is performed by reducing the differential between an actual heat index and a target heat index of an aircraft area, using automatic fan adjustments; where heat index is a user comfort level derived from both temperature and humidity. For further improvements to safety and efficiency, fan speeds are automatically adjusted to accommodate power saving needs, and automatic systems are automatically transitioned to manual control if a fault is detected in the system.

### BACKGROUND OF THE INVENTION

### I. Field of the Invention

The invention relates generally to the field of climate control systems for vehicles, and more specifically, to a hybrid-style automation approach to controlling temperatures and cooling fan speeds in a turbine aircraft.

### II. Description of Related Art

U.S. Patent Application Publication No. 2023/0347712 to “Gentner” is generally directed to HVAC systems for a refuse vehicle (garbage truck). Gentner discloses that HVAC systems inside of a vehicle can control the temperature, humidity, recirculation, and filtration of air inside the vehicle's cabin; that HVAC blower motors can be variable speed; and that an HVAC management system can generally control a blower motor speed according to operator commands or sensor readings, for heating/cooling/humidity control of the vehicle's cab.

U.S. Pat. No. 6,058,715 to “Strang” is generally directed to an air cycle machine for an aircraft. Strang discloses that a controller can control the cooling capacity and airflow rate of an air cycle machine in response to sensor signals such as “avionics temperature, temperature of the air leaving the air cycle machine 14, rate of air flowing into the aircraft cabin 16, rate of air flowing out of the cabin 16, temperature of the cabin 16, etc.”; and that an air cycle machine can use a controlled supply of bleed air from an aircraft engine for HVAC purposes.

### SUMMARY

In some aspects, the techniques described herein relate to a hybrid climate control system for an area in an aircraft, including: one or more sensors configured to determine an actual temperature and an actual heat index of the area, wherein the actual heat index is determined according to temperature and humidity levels; a climate controller, configured to control: a temperature of a conditioned air supply to the area; and a fan speed of a cold air supply to the area; wherein the climate controller controls the temperature and the fan speed according to a control settings configuration, the control settings configuration including: a desired temperature; a selection between automatic temperature control and manual temperature control, wherein automatic temperature control includes determining a differential between the actual temperature and the desired temperature and modifying control of a conditioned air supply based on the differential between the actual temperature and the desired temperature; a desired fan speed; and a selection between automatic and manual fan control, wherein automatic fan control includes determining a differential between the actual heat index and a target heat index and modifying one or more fan speeds to reduce the differential between the actual heat index and the target heat index; and one or more user interfaces electrically connected to the climate controller for the area, wherein the one or more user interfaces are configured for receiving selections of the settings configuration.

In some aspects, the techniques described herein relate to a hybrid climate control system, wherein the aircraft is a turbine aircraft.

In some aspects, the techniques described herein relate to a hybrid climate control system, wherein a separate hybrid climate control system is provided for each of a plurality of aircraft areas, the plurality of aircraft areas including at least a cockpit area and a cabin area.

In some aspects, the techniques described herein relate to a hybrid climate control system, wherein the one or more user interfaces of the cockpit area are electrically connected to every hybrid climate control system of the aircraft, such that the one or more user interfaces of the cockpit area can control the settings configuration of each area of the plurality of aircraft areas.

In some aspects, the techniques described herein relate to a hybrid climate control system, wherein the one or more user interfaces are digital touchscreens which display each selected settings configuration of a plurality of connected aircraft areas.

In some aspects, the techniques described herein relate to a hybrid climate control system, wherein the settings configuration further includes: a series of allowable configurations including: (a) a Fully Manual System State, wherein the temperature and the fan speed are manually controlled; (b) a Partially Automatic System State, wherein the temperature is automatically controlled but the fan speed is manually controlled; and (c) a Fully Automatic System State, wherein the temperature and the fan speed are automatically controlled; and a non-allowed configuration, wherein the system is prevented from operating in a state of both manual temperature control and automatic fan speed control, and if the non-allowed configuration is selected, the system will automatically transition the fan speed to manual control.

In some aspects, the techniques described herein relate to a hybrid climate control system, wherein the user interface further includes a selection between the allowable configurations A, B, and C, for quickly transitioning from one settings configuration to another.

In some aspects, the techniques described herein relate to a hybrid climate control system, wherein the hybrid climate control system is configured to automatically transition one or more automatic control functions to manual control when a failure of the one or more automatic control functions is detected.

In some aspects, the techniques described herein relate to a hybrid climate control system, wherein the climate controller automatically limits fan speed and/or disables one or more fans during one or more aircraft events, such as engine start-up, to reduce workload and power consumption.

In some aspects, the techniques described herein relate to a method for providing hybrid climate controls to an aircraft, including: controlling a temperature of a conditioned air supply and a fan speed for one or more aircraft areas, via one or more climate controllers; detecting, using one or more sensors, an actual temperature and an actual heat index for each of the one or more aircraft areas, wherein the actual heat index of an area is determined according to temperature and humidity levels; selecting a control configuration via user input into one or more user interfaces, the one or more control configurations providing user preferred climate control settings, the settings including: a desired temperature; a selection between automatic and manual temperature control, wherein automatic temperature control includes determining a differential between the actual temperature and the desired temperature and modifying control of a conditioned air supply; a desired fan speed; and a selection between automatic and manual fan control, wherein automatic fan control includes determining a differential between the actual heat index and a target heat index and modifying one or more fan speeds to reduce the differential; and modifying control of the conditioned air supply temperature and the fan speed according to the user preferred climate control settings.

In some aspects, the techniques described herein relate to a method for providing hybrid climate controls to an aircraft, wherein the aircraft is a turbine aircraft.

In some aspects, the techniques described herein relate to a method for providing hybrid climate controls to an aircraft, wherein climate control is provided for each of a plurality of aircraft areas, the plurality of aircraft areas including at least a cockpit area and a cabin area.

In some aspects, the techniques described herein relate to a method for providing hybrid climate controls to an aircraft, further including: providing one or more user interfaces of the cockpit with control over every individual climate controller of the aircraft, such that each area of the aircraft can be controlled by users located in the cockpit.

In some aspects, the techniques described herein relate to a method for providing hybrid climate controls to an aircraft, wherein: the one or more user interfaces are digital touchscreens displaying settings configurations for one or more connected aircraft areas; and wherein users can modify individual or group settings configurations for one or more connected aircraft areas.

In some aspects, the techniques described herein relate to a method for providing hybrid climate controls to an aircraft, wherein user selection of settings configurations further includes: users selecting between a series of allowable configurations consisting of: a Fully Manual System State, wherein the temperature and the fan speed are manually controlled; a Partially Automatic System State, wherein the temperature is automatically controlled but the fan speed is manually controlled; and a Fully Automatic System State, wherein the temperature and the fan speed are automatically controlled; and preventing users from selecting a non-allowed configuration which includes operating in a state of both manual temperature control and automatic fan speed control, and wherein the preventing includes automatically transition the fan speed to manual control.

In some aspects, the techniques described herein relate to a hybrid climate control system, wherein the user interface further includes a selector between the allowable configurations A, B, and C, for rapid transitions from one selected settings configuration to another.

In some aspects, the techniques described herein relate to a method for providing hybrid climate controls to an aircraft, further including automatic transition one or more automatic control functions to manual control when a failure of the one or more automatic control functions is detected.

In some aspects, the techniques described herein relate to a method for providing hybrid climate controls to an aircraft, further including automatically limiting fan speed and/or disabling one or more fans during one or more aircraft events, such as engine start-up, to reduce workload and power consumption.

In some aspects, the techniques described herein relate to a hybrid climate control system for a vehicle, including: one or more sensors configured to determine an actual temperature and an actual heat index of one or more vehicle areas, where the actual heat index of an area is determined according to temperature and humidity levels; a separate climate controller for each of the one or more vehicle areas, configured to control: a temperature of a conditioned air supply to each area; and a fan speed of a cold air supply to each area; wherein each climate controller controls the temperature and the fan speed according to a control settings configuration for each area, the control settings configuration including: a desired temperature; a selection between automatic and manual temperature control, wherein automatic temperature control includes determining a differential between the actual temperature and the desired temperature and modifying control of a conditioned air supply; a desired fan speed; and a selection between automatic and manual fan control, wherein automatic fan control includes determining a differential between the actual heat index and a target heat index and modifying one or more fan speeds to reduce the differential; and at least one user interface electrically connected to each climate controller, wherein at least one user interface includes individual selection of the controls setting configuration for each area, as well as a three-way selection between a series of allowable configurations for each area, the allowable configurations including: (a) a Fully Manual System State, wherein the temperature and the fan speed are manually controlled; (b) a Partially Automatic System State, wherein the temperature is automatically controlled but the fan speed is manually controlled; and (c) a Fully Automatic System State, wherein the temperature and the fan speed are automatically controlled.

In some aspects, the techniques described herein relate to a hybrid climate control system, further including: a non-allowed control settings configuration including operation in a state of both manual temperature control and automatic fan speed control, wherein the hybrid climate control system is configured to automatically transition the fan speed to manual control upon user selection of the non-allowed control settings configuration; configuration of each hybrid climate control system to automatically transition one or more automatic control functions to manual control when a failure of the one or more automatic control functions is detected; and configuration of each climate controller to automatically limit fan speeds and/or disable one or more fans during one or more vehicle events, such as engine start-up, to reduce workload and power consumption.

The details of one or more examples are set forth in the accompanying drawings and the description below. Other features and advantages will be apparent from the description and drawings, and from the claims.

### BRIEF DESCRIPTION OF THE SEVERAL VIEWS OF THE DRAWINGS

FIG. 1 is a diagram of a hybrid climate control system for an area of a turbine aircraft, using an engine fan cooled bleed air configuration.

FIG. 2 is a diagram of a hybrid climate control system for an area of a turbine aircraft, using a ram air cooled bleed air configuration.

FIG. 3 is a diagram of a hybrid climate control system which integrates both an engine fan cooled bleed air system and a ram air cooled bleed air system, for providing climate control to a cockpit and a cabin of a turbine aircraft.

FIG. 4 is a process flowchart demonstrating a method of performing hybrid climate control for a vehicle area.

### DETAILED DESCRIPTION

Integration of various air conditioning systems is a standard practice in modern vehicle design. Modern vehicle users expect that a vehicle's interior will be climate controlled and comfortable for their occupancy, and that such systems will not cause undue distractions and burdens during operations. As such, automation of vehicle climate control systems has become an increasingly desired feature over traditionally manual climate control systems.

In a traditionally manual climate control system, a vehicle user must frequently adjust both a temperature of a conditioned air supply, and a fan speed for blowing air, in order to maintain a comfortable temperature over time. Manual climate control systems introduce a number of problematic scenarios for vehicle users. For example, users may desire a rapid temperature change when entering a vehicle that is either too hot or cold and will adjust climate controls to output extremely hot or cold air. This introduces later complications, as extreme climate control settings will cause the vehicle cabin to become progressively more uncomfortable over time, as the vehicle overcorrects the cabin temperature. Likewise, conditions such as external temperature change and solar heating can thermally impact a vehicle's internal temperatures over time, often in unpredictable ways. In order to account for these issues, a vehicle user must continuously change climate control settings as both temperature and humidity inside the vehicle fluctuate. For these reasons, manual climate control systems can be both frustrating and distracting for users operating a vehicle.

While modern automated climate control systems are progressively being integrated into vehicle designs, there are a number of issues that have yet to be fully addressed. Modern automated vehicle systems typically provide means for selecting a desired temperature, and the system attempts to automatically adjust the temperature of the conditioned air supply to achieve/maintain the user's preferred temperature, however, these systems fail to provide automatic adjustment of fan speeds and humidity control. Without automatic fan speed control, a vehicle user with an automated climate control system is still expected to provide continuous adjustments to fan speed in order to maintain cabin comfort. This is particularly true in the case of turbine aircraft, where cooling is supplied almost exclusively by cool air pulled into the cabin via one or more fan blowers, and fan speed is necessarily adjusted over time to accommodate heating from engine bleed air, changes in humidity, radiative heat from human passengers, etc.

Modern climate control systems fail to provide automatic control of fan speeds primarily due to the complicated nature of predicting a target fan speed. While maintaining a constant internal vehicle temperature, a plurality of additional climate control variables continue to dynamically change, including user comfort with current fan speeds at a current conditioned air temperature, humidity level, and airflow/circulation in the vehicle's interior which are difficult to predict based on user settings alone.

Automated control of conditioned air is typically performed by comparing a “target temperature” to an “actual temperature” measured in the vehicle's cabin, and adjustments to the temperature of the conditioned air supply are made to reduce the differential between the target and actual temperature. In contrast, there is no well-known method of determining a “target fan speed” for a vehicle cabin, such that a similar control step can be performed. Actual fan speed does not vary dynamically like temperature, so there is no differential to calculate between a target and actual speed over time. Likewise, a user preferred fan speed will necessarily change over time since a user cannot reliably predict other comfort metrics like humidity and cabin airflow which introduce discomfort over time. As such, user selection of a “target fan speed” is essentially identical to manual control and cannot be used as the basis for automation. Thus, a novel means of selecting a “target fan speed”, beyond mere user selection, must be determined in order to provide automated fan speed.

Accordingly, there exists a need for automatic fan speed controls in an improved vehicle climate control system, where this automated system is capable of controlling both temperature and fan speed for the entire duration of a vehicle operation. Likewise, there exists a need for a streamlined user interface system for selecting between hybrid climate control configurations of said system, where a user can transition with minimal distraction between manual controls, semi-automatic controls, and fully-automatic controls.

In the following detailed description of example embodiments, reference is made to specific example embodiments by way of drawings and illustrations. These examples are described in sufficient detail to enable those skilled in the art to practice what is described and serve to illustrate how elements of these examples may be applied to various purposes or embodiments. Other embodiments exist, and logical, mechanical, electrical, and other changes may be made. Features or limitations of various embodiments described herein, however important to the example embodiments in which they are incorporated, do not limit other embodiments, and any reference to the elements, operation, and application of the examples serve only to define these example embodiments. Features or elements shown in various examples described herein can be combined in ways other than shown in the examples, and any such combinations is explicitly contemplated to be within the scope of the examples presented here. The following detailed description does not, therefore, limit the scope of what is claimed.

Particularly, an example embodiment of the invention is described in detail, wherein the claimed hybrid climate control system is implemented as the climate control system for a turbine aircraft. This detailed embodiment in no way limits the relevance of the disclosed invention to turbine aircraft system, as the claimed invention can by readily utilized to improve numerous aircraft types and general vehicle systems.

Turbine aircraft (Turboprop, turboshaft, and turbofan) require that the cockpit and cabin are ventilated, temperature controlled and pressurized to maintain a habitable environment for the passengers and crew. To heat and pressurize the compartment, high-temperature and high-pressure bleed air is typically extracted from the engine's compressor stage(s), temperature controlled, and provided to the compartment. To cool the compartment, a vapor cycle compression system may be used to cool recirculated air. Inflow temperature is automatically controlled to a set point by modulating a temperature control valve that varies either the quantity of cooling air going through a heat exchanger or the amount of hot air bypassing a heat exchanger.

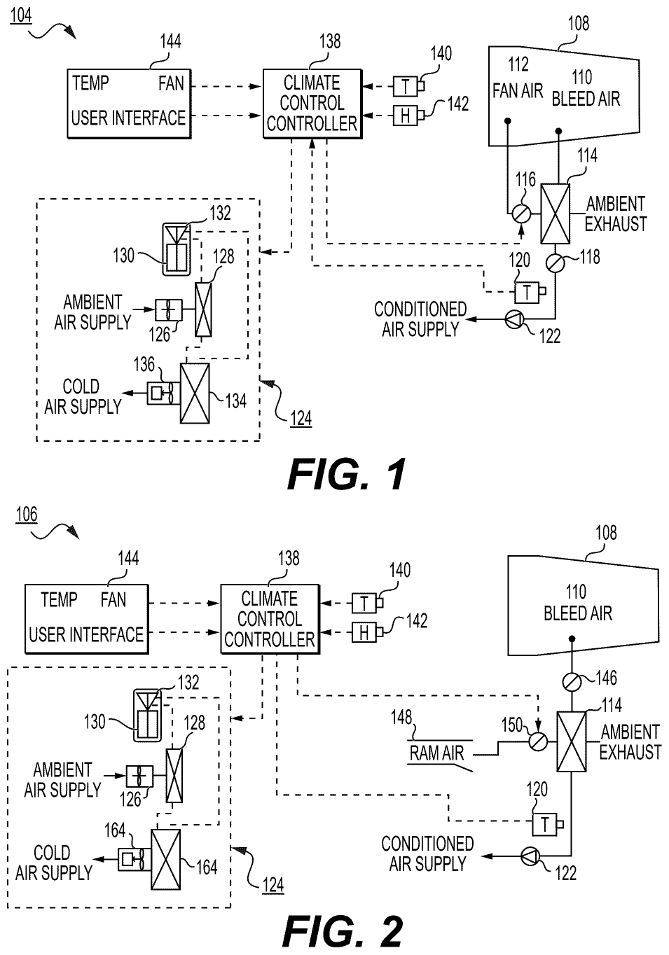

FIG. 1 depicts an example embodiment of the hybrid climate control system 100 for an aircraft area 102 of a turbine aircraft. The example hybrid climate control system 100 comprises a fan air cooled bleed air inflow system 104 for providing heating, a vapor cooling cycle 124 for providing cooling, a climate control controller 138 for controlling the fan air cooled bleed air inflow system 104 and the vapor cooling cycle 124, and a user interface 144 which is configured to supply commands to the climate control controller 138 according to user selected settings. In some examples, the hybrid climate control system 100 depicted can be implemented into any internal aircraft area 102, such as a cockpit or a cabin. In some examples, one or more hybrid climate control systems 100 can be implemented in a single aircraft for one or more areas, and the one or more hybrid climate control systems can be individually controlled for each area of the aircraft or controlled in one or more combinations.

For heating the aircraft area 102, the hybrid climate control system 100 uses a fan air cooled bleed air inflow system 104 with a first engine 108. The first engine 108 is in some examples, a turbojet engine, a turboprop engine, a turbofan engine, a turboshaft engine, or another type of aircraft engine. Pressurized high-temperature bleed air 110 is extracted from the at least one engine 108 and cooled with low-temperature engine fan air 112 in a bleed air heat exchanger 114. The flow rate of low-temperature engine fan air 112 is controlled using a fan air supply valve 116, such that the appropriate interaction of bleed air 110 and fan air 112 occurs within the heat exchanger 114 to output a desired conditioned air temperature. A conditioned air supply valve 118 is located downstream of the heat exchanger 114 to reduce, by adjusting the operating pressure, or fully prevent the flow of conditioned air from entering the aircraft area 102. In some examples this valve 118 is manually controlled, and in other examples this valve is electrically controlled by the climate control controller 138 or another other aircraft system controller. A conditioned air temperature sensor 120 is located downstream of the bleed air heat exchanger 114 and is configured to provide temperature data to the climate control controller 138. Temperature feedback from the conditioned air temperature sensor 120 is utilized by the climate control controller 138 during manual control in order to adjust the fan air supply valve 116, and resultingly alter the temperature of the conditioned air stream; where control based on conditioned air temperature sensor 120 is called inner loop control. The stream of conditioned air which is allowed to pass through the conditioned air supply valve 118 is lastly passed through a pressure vessel check valve 122, to ensure that ambient air from aircraft area 102 does not vent into the conditioned air ducting when the system is selected off. In alternative embodiments, the pressure of the airstream can be regulated upstream of the heat exchanger 114 instead of, or in combination with, pressure regulators downstream of the heat exchanger 114.

For cooling the aircraft area 102, the hybrid climate control system 100 uses a conventional vapor cooling cycle 124, which cools air recirculated from within the aircraft area 102. In the vapor cooling cycle 124, a refrigerant in a low-pressure vapor state is passed through a compressor 132, powered by a compressor motor 130, where the refrigerant is compressed into a high-pressure vapor state. The high-pressure vapor refrigerant is the passed through a condenser heat exchanger 128, where low-temperature ambient air is drawn from outside the aircraft using an intake fan 126 and blown across the condenser heat exchanger 128, to cool and condense the refrigerant into a low-temperature high-pressure liquid state. The low-temperature high-pressure liquid refrigerant is expanded into a low-temperature low-pressure liquid/vapor state and provided to an evaporator heat exchanger 134. An evaporator fan 136 pulls recirculated air from the aircraft area 102 across the evaporator heat exchanger 134 such that the low-temperature refrigerant cools the recirculated air. The recirculated air cooled by the evaporator heat exchanger 134 is then vented back to the aircraft area 102 as a cold air supply for climate control. The heat from the initially recirculated air across the evaporator heat exchanger 134 transitions the refrigerant into a low-pressure vapor state that can be provided to the compressor, thus restarting the vapor cooling cycle 124. The speed of the evaporator fan 136 changes both the temperature and humidity of the recirculated air, where both temperature and humidity can be used to determine a heat index of the aircraft area 102. Accordingly, the speed of the evaporator fan 136 can be controlled by the climate control controller 138 to modify the heat index of an aircraft area 102, such that a comfortable heat index for a user preferred temperature is maintained.

Regarding the fan air cooled bleed air inflow system 104, the system is controlled via the climate control controller 138 and can be operated either in a manual temperature control configuration or an automatic temperature control configuration, according to a user selection. In the manual temperature control configuration, also called inner loop temperature control, the climate control controller 138 disregards temperature sensors within the aircraft area (i.e. sensor 140) and measures the temperature of the conditioned airstream using conditioned air temperature sensor 120 mounted downstream of the bleed air heat exchanger 114. The value measured by conditioned air temperature sensor 120 is compared against the target temperature value set by the user, to determine a temperature differential. The climate control controller 136 accordingly adjusts the fan air supply valve 116 to increase or decrease the cooling of the high-temperature bleed air 110 in bleed air heat exchanger 114, such that a differential between the measured temperature and the target temperature is reduced to a minimum level. In the automatic temperature control configuration, also called outer loop control, the climate control controller 138 further relies on an aircraft area temperature sensor 140 to determine an actual aircraft area temperature; wherein, the climate control controller 138 dynamically modifies the temperature of the output conditioned air to reduce a difference between the actual aircraft area temperature and the target aircraft area temperature. This temperature control style is referred to as cascading dual loop control system, where the automatic control outer loop can be deactivated while still maintaining manual inner loop control over the temperature output.

Regarding the vapor cooling cycle 124, the speed of evaporator fan 136 is controlled by the climate control controller 138 which operates in either a manual fan speed configuration or an automatic fan speed configuration, according to a user selection. In the manual fan speed configuration, the evaporator fan 136 operates at a fixed speed which directly corresponds to a user fan speed setting. In some examples, a plurality of aircraft areas are supplied cold air from a plurality of evaporator fans 136, and each fan 136 individually operates only when and where it is instructed to operate by user selection. In the automatic fan speed configuration, the climate control controller 138 determines a desired comfort level for the aircraft area 102 which corresponds to a target heat index; where the target heat index is derived from the target aircraft area temperature provided by the user; where the aircraft humidity sensor 142 and temperature sensor 140 measurements are used to determine an actual heat index of the aircraft area 102. The climate control controller 138 automatically modifies the speed of the evaporator fan 136 to reduce a differential between the target heat index and the actual heat index of the area. In some examples, as the differential between the target heat index and the actual heat index decreases, the speed of the evaporator fan 136 is automatically reduced to prevent discomfort due to heat index overcorrection.

Users are able to issue commands to the climate control controller 138 of an aircraft area 102 through a user interface 144, which allows for selection between various settings configurations. Users may select through the user interface 144: a desired temperature, a desired fan speed, between manual and automatic temperature control, and between manual and automatic fan speed control. In some examples, user interface 144 is configured to receive input from a user through tactile, audio, or video input. Examples of user interface 144 include a digital interface on a touchscreen display, a vehicle console or control panel, or any other type of device which detects inputs from a user. In some examples the user interface 144 is directly integrated with an existing vehicle display or control system, is a separate system, or is integrated within another system on the aircraft.

In some examples, the user interface 144 and the climate control controller 138 may operate using one or more computer systems, which comprise processors executing a series of steps stored within one or more non-transitory storage mediums. In some examples, both devices 144 138 may operate using separate computer systems which are electrically or wirelessly connected, while in other examples the systems 144 138 are integrated into a single computer system. In further examples, one or both of the systems 144 and 138 are integrated into existing aircraft computer systems and controls.

The user interface 144, and by extension the climate control controller 138, is always in a configured state, wherein either manual or automatic temperature control is active, and either manual or automatic fan speed control is active. The climate control controller 138 can therefore operate in either fully manual control, fully automatic control, or a hybrid state of manual and automatic control. To simplify controls, these selectable configurations can be combined into three allowable system states:
1. Manual Temperature & Manual Fans-Fully Manual System
2. Automatic Temperature & Manual Fans-Partially Automatic System
3. Automatic Temperatures & Automatic Fans-Fully Automatic System

The user interface 144 allows for a quick three-way selection between the allowable system states for ease of use. In some examples, transitioning from one state to another can occur with a single user interaction on the user interface 144, such as pressing a button on a touchscreen display which corresponds to the desired system state. The user interface 144 additionally comprises controls for selecting a desired temperature and fan speed in the aircraft area. In a preferred use case, the user selects the desired temperature and fan speed before initiating vehicle operations, such that the hybrid climate control system can automatically maintain user comfort without distracting the vehicle user; however, a user may update the desired temperature and fan preferences if desired. The user interface further comprises labels which indicate various settings for temperature and fan speed, including options such as: increase/decrease/high/low, hot/warm/cool/cold, or other verbiage which aids the user in selecting preferred settings.

The user interface 144 can also restrict which states and settings are currently available and/or allowable for selection, and systems 144 and/or 138 can automatically transition a setting from automatic control to manual control if needed. For example, the climate control controller 138 requires automatic temperature control in order to operate the fans automatically; thus, Manual Temperature and Automatic Fans is a non-allowable system state. If the user attempts to initiate a Manual Temperature and Automatic Fans state, systems 144 and/or 138 will transition fan control to a manual state. In some examples, this automatic transition is accompanied with one or more indications that manual control is active and that a non-allowed system state was previously selected. In some examples, the indications include: a warning notification, and audio alert, a tactile feedback response, an indicator light, a physical switch manipulation, or another form of indication.

System failures, malfunctions, and errors are common issues known to occur within any automatic system over long operational periods, and these issues are typically addressed in aircraft design by including a secondary manual set of “backup controls”. Upon detection of a failure, malfunction, or error within the automatic controls, the user interface 144 and/or the climate control controller 138 can automatically transition the malfunctioning system to manual control. This feature eliminates the need for backup manual controls, and further streamlines the simplicity of user interaction with the system. In some examples, this automatic transition is accompanied with one or more indications that manual control was activated and that an issue has occurred, including: a warning notification, and audio alert, a tactile feedback response, an indicator light, a physical switch manipulation, or another form of indication. In some examples, the indication also provides the user with information about the issue, including the issue's: source, severity, appropriate response, or another indication relevant to identifying or addressing the issue.

In some examples, the computer-readable non-transitory storage mediums may contain software which facilitates the functions of systems 144 and 138. In some examples, the computer-readable non-transitory storage mediums may comprise memory storage configured to store operational data over time. In some examples, the stored operational data can be used to maintain user settings between operations or save selectable settings configurations, such that fully-automatic climate control can be maintained for a plurality of operations with minimal or no user input. Additionally, in some examples, the hybrid climate control system 100 may incorporate known machine learning functions to improve and adjust the system, and/or adjust settings for a particular user, further increasing comfort and minimizing distractions.

FIG. 2 depicts an alternate embodiment of the hybrid climate control system 100, wherein the fan air cooled bleed air inflow system 104 is replaced with a ram air cooled bleed air inflow system 106. The ram air cooled bleed air inflow system 106 uses a low-temperature ram air supply 148 in place of low-temperature engine fan air 112 to cool the pressurized high-temperature bleed air 110 in the heat exchanger 114. An engine bleed air shutoff valve 146 is located between the heat exchanger 114 and the first engine 108 to reduce, by adjusting the operating pressure, the flowrate of pressurized high-temperature bleed air 110 as desired, and a ram air shutoff valve 150 is located between the ram air supply 148 and the heat exchanger 114 for controlling the flowrate of ram air. The ram air cooled bleed air inflow system 106 is a functionally equivalent system to the fan air cooled bleed air inflow system 104, and a turbine aircraft's hybrid climate control system 100 can use one or more of both system types 104 106 in any one configuration. In additional embodiments, different means for providing low-temperature air to heat exchanger 114 can be implemented in the hybrid climate control system 100 without diverging from the scope of what is claimed.

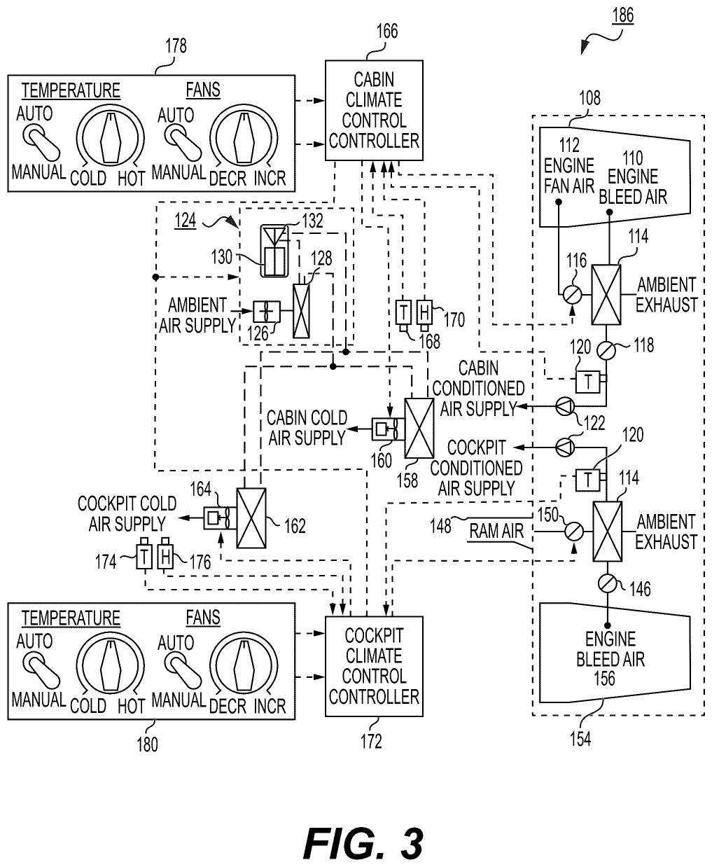

FIG. 3 depicts an example embodiment of a two-engine hybrid climate control system 186 for a turbine aircraft, wherein the aircraft uses both a fan air cooled bleed air inflow system 104 and a ram air cooled bleed air inflow system 106 to provide climate control to an aircraft cabin 182 (not shown) and cockpit 184 (not shown) respectively. First engine 108 is configured in a fan air cooled bleed air inflow system 104 for providing climate control to the cabin 182, while a second engine 154 is configured in a ram air cooled bleed air inflow system 106 to provide climate control to the cockpit 184. The two systems 104 106 share a central vapor cooling system 124, with distinct evaporator systems for each system 104 106. Chilled refrigerant is provided to a cabin evaporator heat exchanger 158, while chilled refrigerant is also provided simultaneously to a cockpit evaporator heat exchanger 162. Once the chilled refrigerant is used to cool both aircraft areas 182 184, it is rejoined in a single stream to be compressed by the shared refrigerant compressor 132. The cabin 182 has a separate climate control controller 166, sensors 168 170, and user interface 178, from the cockpit's 184 climate control controller 172, sensors 147 176, and user interface 180; such that climate control can be provided for each area independently.

User interfaces 178 180 are depicted in an example analog configuration, with two sets of physical switches and dials. In some examples the selections between manual and automatic temperature/fans can be simplified into a three-position selection switch of allowable system states, as described above. In other examples, the pair of analog user interfaces 178 180 could be substituted with another equivalent user interface system, such as a single digital touchscreen display with individual controls for both areas 182 184 displayed. In further examples, a universal or group control option is made available for user interfaces 178 180, such that the two areas can be controlled jointly with only a single set of user control settings.

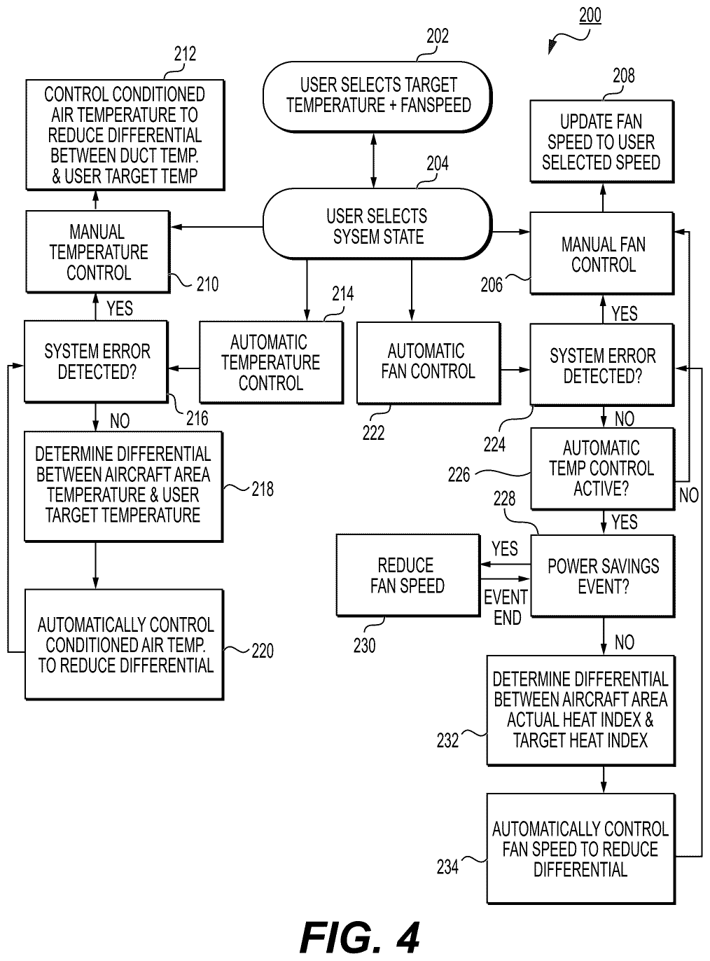

FIG. 4 depicts a method 200 of controlling the hybrid climate control system 10. The method begins with a user settings detection 202 where the system 100 detects a user setting of a desired target temperature and a target fan speed, and a user selected system state detection 204 where the system detects a user selection between manual and automatic temperature control and between manual and automatic fan speed control. After system state detection 204, the system executes two processes; one temperature process and one fan process.

Temperature control begins with a selection between a manual temperature control process 210 and an automatic temperature control process 214. In manual temperature control process 210, also called “inner loop” control, the system determines a duct temperature of the conditioned air supply using bleed air temperature sensor 116 and compares the value to the user target values 202. In a control step 212, the system adjusts the amount of low-temperature air that is provided to the heat exchanger 106 such that a differential between the temperature detected by bleed air temperature sensor 116 and the target value of 202 is reduced to a minimum value. In automatic temperature control process 214, also called “outer loop” control, the system performs a check 216 to determine if any system errors exist that would impact automatic temperature control functions. Should any errors be detected in check 216, the system automatically switches to manual temperature control and initiates step 210; additionally, detection of errors in check 216 may, in some examples, be accompanied by a warning 236 (not shown) which provides information about the error to the user via the user interface 134. If no system errors are detected in check 216, a measurement step 218 is initiated, wherein the system determines a differential between the temperature of the aircraft area provided by temperature sensor 140 and the target temperature 202. Finally, an automatic control step 220 is performed, wherein the bleed air temperature is adjusted to reduce the differential between the aircraft area temperature and the target temperature determined in step 218 to a minimum value.

Fan control begins with a selection between manual fan control process 206 and automatic fan control process 222. In manual fan control process 206, the system executes a direct fan control step 208 where the controlled fan speed of evaporator fan 132 is set to match user fan settings 202. In an automatic fan control process 222, the system first performs a check 224 to determine if any system errors exist that would impact automatic fan speed control functions. Should any errors be detected in check 224, the system automatically switches to manual fan control and initiates step 206; additionally, detection of errors in check 224 may, in some examples, be accompanied by a warning 236 (not shown) which provides information about the error to the user via the user interface 134. If no errors are detected in check 224, the system then performs a check 226 to determine if automatic temperature control 214 is also selected. If automatic temperature control 214 is not the selected temperature control process, the system switches to manual control and initiates step 206. If automatic temperature control process 214 is selected, the system performs a power saving event check 228 to determine if an aircraft event requiring reduced fan workload and/or power saving initiatives is ongoing, including: aircraft operation on battery power, engine startups, or other events where battery power should be preserved. If the aircraft is experiencing a power savings event, an automatic reduction in fan speed is initiated until the event has ended or another event occurs which ends the power saving initiative. In some examples, the reduction in fan speed can include: a speed reduction to a set value, a dynamic speed reduction, a total shutdown, or another method of reducing fan speed. When check 228 determines that no power saving events are ongoing, the process proceeds to measurement step 232, wherein the system determines an actual heat index of the aircraft area based on measurements provided from temperature sensor 140 and humidity sensor 142. Measurement step 232 determines, based on the user provided settings 202, a target heat index which is predicted be comfortable for the user, and then determines a differential between the actual heat index of the aircraft area and the target heat index. Finally, a control step 234 dynamically updates the speed of evaporator fan 132 to reduce the differential between the target heat index and the actual heat index. In some examples, fan speed reductions due to power saving events can be initiated in both manual fan control and automatic fan control states, where manual fan control reverts to step 208 after completion of the power saving event.

Once a final control step 208 212 220 234 of a process is reached, the system will maintain that step to provide the appropriate control process requested by the user. The system will reinitiate the process each time a new system state is detected 204 and/or whenever another change, event, or occurrence in the vehicle is determined to impact climate control functions. Both the explicit steps provided, and the order in which they are presented, are merely provided as an example, and do not limit the scope of the invention. Steps may be added, removed, substituted, reordered, etc. within the scope of the disclosed invention, and obvious modifications and/or variation of this process are also encompassed in what is disclosed. In some examples, the system can initiate or repeat the process starting from any of the steps provided in the method 200. In some examples, one or more steps of method 200 can be controlled or adjusted by user settings changes, to further refine climate control functions as desired. In some examples, the steps can be performed by a computer system (i.e., a processor performing the steps of method 200 which are stored on non-transitory computer readable media). In some examples, the user settings 202 can be stored (automatically or as a saved profile) in computer memory, such that they are retained for later operations.

In alternative embodiments, the hybrid climate control system 100 can be implemented in vehicles other than turbine engine aircraft, such as: jet aircraft, rotorcraft, automobiles, or any other vehicle which is capable of producing engine bleed air. Minor modifications may be made to the structure of the hybrid climate control system 100, such that it may be properly integrated into such vehicles. One of ordinary skill in the art would be readily capable of performing such modifications without undue experimentation and without deviating from the scope of the disclosed invention.

Although specific embodiments have been illustrated and described herein, any arrangement that achieves the same purpose, structure, or function may be substituted for the specific embodiments shown. This application is intended to cover any adaptations or variations of the example embodiments of the invention described herein. These and other embodiments are within the scope of the following claims and their equivalents.

The invention claimed is:

1. A hybrid climate control system for an area in an aircraft, comprising:
one or more sensors configured to determine an actual temperature and an actual heat index of the area, wherein the actual heat index is determined according to temperature and humidity levels;
a climate controller, configured to control:
a temperature of a conditioned air supply to the area; and
a fan speed of a cold air supply to the area;
wherein the climate controller controls the temperature and the fan speed according to a control settings configuration, the control settings configuration comprising:
a desired temperature;
a selection between automatic temperature control and manual temperature control, wherein automatic temperature control comprises determining a differential between the actual temperature and the desired temperature and modifying control of a conditioned air supply based on the differential between the actual temperature and the desired temperature;
a desired fan speed; and
a selection between automatic and manual fan control, wherein automatic fan control comprises determining a differential between the actual heat index and a target heat index and modifying one or more fan speeds to reduce the differential between the actual heat index and the target heat index; and
one or more user interfaces electrically connected to the climate controller for the area, wherein the one or more user interfaces are configured for receiving selections of the settings configuration.

2. The hybrid climate control system of claim 1, wherein the aircraft is a turbine aircraft.

3. The hybrid climate control system of claim 1, wherein a separate hybrid climate control system is provided for each of a plurality of aircraft areas, the plurality of aircraft areas comprising at least a cockpit area and a cabin area.

4. The hybrid climate control system of claim 3, wherein the one or more user interfaces of the cockpit area are electrically connected to every hybrid climate control system of the aircraft, such that the one or more user interfaces of the cockpit area can control the settings configuration of each area of the plurality of aircraft areas.

5. The hybrid climate control system of claim 3, wherein the one or more user interfaces are digital touchscreens which display each selected settings configuration of a plurality of connected aircraft areas.

6. The hybrid climate control system of claim 1, wherein the settings configuration further comprises:
a series of allowable configurations comprising:
A.) a Fully Manual System State, wherein the temperature and the fan speed are manually controlled;
B.) a Partially Automatic System State, wherein the temperature is automatically controlled but the fan speed is manually controlled; and
C.) a Fully Automatic System State, wherein the temperature and the fan speed are automatically controlled; and
a non-allowed configuration, wherein the system is prevented from operating in a state of both manual temperature control and automatic fan speed control, and if the non-allowed configuration is selected, the system will automatically transition the fan speed to manual control.

7. The hybrid climate control system of claim 6, wherein the user interface further comprises a selection between the allowable configurations A, B, and C, for quickly transitioning from one settings configuration to another.

8. The hybrid climate control system of claim 1, wherein the hybrid climate control system is configured to automatically transition one or more automatic control functions to manual control when a failure of the one or more automatic control functions is detected.

9. The hybrid climate control system of claim 1, wherein the climate controller automatically limits fan speed and/or disables one or more fans during one or more aircraft events, such as engine start-up, to reduce workload and power consumption.

10. A method for providing hybrid climate controls to an aircraft, comprising:
controlling a temperature of a conditioned air supply and a fan speed for one or more aircraft areas, via one or more climate controllers;
detecting, using one or more sensors, an actual temperature and an actual heat index for each of the one or more aircraft areas, wherein the actual heat index of an area is determined according to temperature and humidity levels;
selecting a control configuration via user input into one or more user interfaces, the one or more control configurations providing user preferred climate control settings, the settings comprising:
a desired temperature;
a selection between automatic and manual temperature control, wherein automatic temperature control comprises determining a differential between the actual temperature and the desired temperature and modifying control of a conditioned air supply;
a desired fan speed; and
a selection between automatic and manual fan control, wherein automatic fan control comprises determining a differential between the actual heat index and a target heat index and modifying one or more fan speeds to reduce the differential; and
modifying control of the conditioned air supply temperature and the fan speed according to the user preferred climate control settings.

11. The method for providing hybrid climate controls to an aircraft of claim 8, wherein the aircraft is a turbine aircraft.

12. The method for providing hybrid climate controls to an aircraft of claim 8, wherein climate control is provided for each of a plurality of aircraft areas, the plurality of aircraft areas comprising at least a cockpit area and a cabin area.

13. The method for providing hybrid climate controls to an aircraft of claim 12, further comprising:
providing one or more user interfaces of the cockpit with control over every individual climate controller of the aircraft, such that each area of the aircraft can be controlled by users located in the cockpit.

14. The method for providing hybrid climate controls to an aircraft of claim 12, wherein:
the one or more user interfaces are digital touchscreens displaying settings configurations for one or more connected aircraft areas; and
wherein users can modify individual or group settings configurations for one or more connected aircraft areas.

15. The method for providing hybrid climate controls to an aircraft of claim 10, wherein user selection of settings configurations further comprises:
users selecting between a series of allowable configurations consisting of:
a Fully Manual System State, wherein the temperature and the fan speed are manually controlled;
a Partially Automatic System State, wherein the temperature is automatically controlled but the fan speed is manually controlled; and
a Fully Automatic System State, wherein the temperature and the fan speed are automatically controlled; and
preventing users from selecting a non-allowed configuration which comprises operating in a state of both manual temperature control and automatic fan speed control, and wherein the preventing comprises automatically transition the fan speed to manual control.

16. The hybrid climate control system of claim 15, wherein the user interface further comprises a selector between the allowable configurations A, B, and C, for rapid transitions from one selected settings configuration to another.

17. The method for providing hybrid climate controls to an aircraft of claim 10, further comprising automatic transition one or more automatic control functions to manual control when a failure of the one or more automatic control functions is detected.

18. The method for providing hybrid climate controls to an aircraft of claim 10, further comprising automatically limiting fan speed and/or disabling one or more fans during one or more aircraft events, such as engine start-up, to reduce workload and power consumption.

19. A hybrid climate control system for a vehicle, comprising:
one or more sensors configured to determine an actual temperature and an actual heat index of one or more vehicle areas, where the actual heat index of an area is determined according to temperature and humidity levels;
a separate climate controller for each of the one or more vehicle areas, configured to control:
a temperature of a conditioned air supply to each area; and
a fan speed of a cold air supply to each area;
wherein each climate controller controls the temperature and the fan speed according to a control settings configuration for each area, the control settings configuration comprising:
a desired temperature;
a selection between automatic and manual temperature control, wherein automatic temperature control comprises determining a differential between the actual temperature and the desired temperature and modifying control of a conditioned air supply;
a desired fan speed; and
a selection between automatic and manual fan control, wherein automatic fan control comprises determining a differential between the actual heat index and a target heat index and modifying one or more fan speeds to reduce the differential; and
at least one user interface electrically connected to each climate controller, wherein the at least one user interface comprises individual selection of the controls setting configuration for each area, as well as a three-way selection between a series of allowable configurations for each area, the allowable configurations comprising:
A.) a Fully Manual System State, wherein the temperature and the fan speed are manually controlled;
B.) a Partially Automatic System State, wherein the temperature is automatically controlled but the fan speed is manually controlled; and
C.) a Fully Automatic System State, wherein the temperature and the fan speed are automatically controlled.

20. The hybrid climate control system of claim 19, further comprising:
a non-allowed control settings configuration comprising operation in a state of both manual temperature control and automatic fan speed control, wherein the hybrid climate control system is configured to automatically transition the fan speed to manual control upon user selection of the non-allowed control settings configuration;
configuration of each hybrid climate control system to automatically transition one or more automatic control functions to manual control when a failure of the one or more automatic control functions is detected; and
configuration of each climate controller to automatically limit fan speeds and/or disable one or more fans during one or more vehicle events, such as engine start-up, to reduce workload and power consumption.
